(19) United States
(12) Patent Application Publication
(10) Pub. No.: US 2008/0101770 A1
(43) Pub. Date: May 1, 2008

(54) Method and Apparatus for Remotely Controlling a Receiver According to Content and User Selection

(75) Inventors: Christopher Commons, Carmel, IN (US); Martin R. Wachter, Phoenix, MD (US); Robert A. Bouterse, Danville, IN (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Digital Networks North America, Inc., Cupertino, CA (US)

(21) Appl. No.: 11/949,677

(22) Filed: Dec. 3, 2007

Related U.S. Application Data
(63) Continuation-in-part of application No. 10/935,068, filed on Sep. 7, 2004, now Pat. No. 7,305,694.
(60) Provisional application No. 60/500,582, filed on Sep. 4, 2003.

(51) Int. Cl. H04N 7/26

(52) U.S. Cl. 386/124; 386/E05.003

(57) ABSTRACT

System and method for automatically controlling a media receiver by instructing the media receiver to use a particular receiver connection and to play a selected media unit using one of a plurality of play modes according to characteristics of the media unit. Media units may be encoded using any of a variety of encoding formats. The media management system may interface with a media receiver to select media receiver connections in accordance with the media type of the media unit. The media management system may also interface with the media receiver to set media receiver settings for playing the selected media unit according to the media receiver settings selected for a play mode corresponding to the characteristics of the selected media unit.

### RELATED APPLICATIONS

This application is a continuation-in-part application of U.S. patent application Ser. No. 10/935,068, filed Sep. 7, 2004, now U.S. Pat. No. 7,305,694, which claims the benefit of U.S. Provisional Patent Application No. 60/500,582, filed Sep. 4, 2003.

### FIELD OF INVENTION

The current invention relates to entertainment devices and, more specifically, to systems and methods for automatic control over peripheral equipment connected to media management systems.

### BACKGROUND

Media management systems are becoming increasingly popular among consumers of entertainment media who need assistance in managing their ever-growing collections of CD's, DVD's, MP3 files and media-playing equipment. Media management systems interface with a variety of sources of media. For example, a media management system may receive media from different CD-changers, different DVD-changers, the Internet, a CD player, a DVD player, a personal computer and a hard disk drive. Media management systems also interface with a variety of media players. For example, the same media management system may play media on a monitor, a television, and on different audio receivers. Media management systems are also typically able to display information about the media available on the connected sources of media on a user interface. The user interface allows the user to communicate instructions to play selected pieces of media.

Developers of media management systems aim to interface with as wide a variety of media sources as possible. Different media sources make media available in forms that provide different capabilities for enhancing the user experience. Web-sites on the Internet offer users the convenience of downloading music or other audio as MP3 files. Video works and music are now available on different types of discs such as DVD, CD, Super-Audio CD (SACD), WAV, MP3, DVD-Audio, etc. offering the user options such as choices in surround modes available to the user. In this regard, audio/video receivers now have a variety of inputs to allow a user to connect alternative media sources. A user may connect media sources, audio receivers and video players to a media management system to take advantage of the many options available to experience the media.

Providing such variety of capabilities imposes on the user the burden of learning and understanding the capabilities available on the user's media management system. Moreover, the user typically manually configures the manner in which a selected piece of media will be played each time it is played. For example, a user may direct an SACD disc to a 6-channel analog input on the receiver when playing an SACD disc. Then, if the user wishes to listen to an MP3 file, the user may manually configure the media management system to direct the output to a 2-channel input on the receiver. Such manual configuration for each type of media source becomes burdensome to the user.

Based on the foregoing, a need exists for automatically configuring receivers to play media using sound and video modes according to characteristics of the media.

### BRIEF DESCRIPTION OF THE DRAWINGS

Exemplary embodiments of the invention are described herein with reference to the drawings, in which:

FIG. 1 is a block diagram illustrating an exemplary media management system;

FIG. 2 is a block diagram illustrating an exemplary configuration process;

FIG. 3 is a block diagram illustrating an exemplary system and method for playing media in accordance with a user configuration;

FIG. 4 depicts a media unit record in accordance with an exemplary embodiment of the present invention;

FIG. 5 is a flow chart depicting a set of functions that may be carried out with an exemplary embodiment of the present invention; and

FIG. 6 is another block diagram illustrating an exemplary system and method for playing media in accordance with a user configuration.

### DETAILED DESCRIPTION

In the following detailed description, numerous specific details are set forth in order to provide a thorough understanding of the invention. However, it will be understood that the present invention may be practiced without these specific details. In other instances, well-known methods, procedures, components and circuits have not been described in detail, so as not to obscure the present invention.

1. Overview

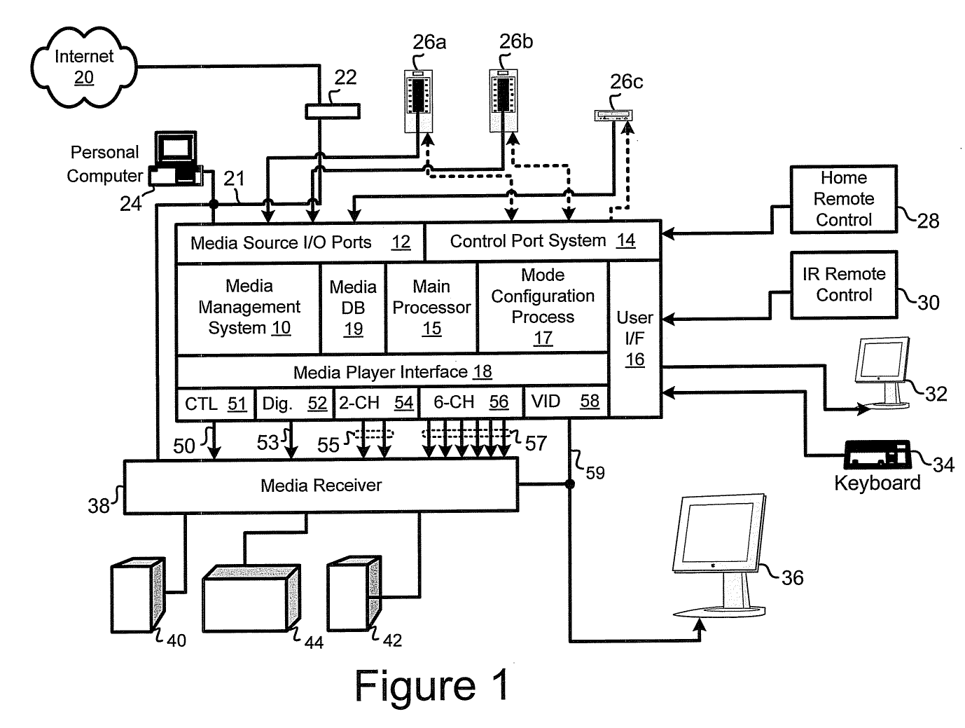

FIG. 1 is a block diagram of an exemplary media management system 10 that includes: (i) a plurality of media source input/output (I/O) ports 12, (ii) a control port system 14, (iii) a main processor 15, (iv) a user interface 16, (v) a mode configuration process 17, (vi) a media player interface 18, (vii) a media database 19, (viii) a control signal connection 51, (ix) a digital connection 52, (x) a 2-channel audio connection 54, (xi) a 6-channel audio connection 56, and (xii) a video connection 58.

It should be understood, however, that this and other arrangements described herein are provided for purposes of example only. As such, those skilled in the art will appreciate that other arrangements and other elements (e.g. machines, interfaces, functions, orders, and groupings of functions, etc.) can be used instead, and some elements may be omitted altogether. Further, many of the elements described herein are functional entities that may be implemented as discrete or distributed components or in conjunction with other components, in any suitable combination and location, and as any suitable combination of hardware, firmware, and/or software.

The control signal connection 51, the digital connection 52, the 2-channel analog connection 54, the 6-channel analog connection 56, and the video connection 58 are communicatively coupled to a media receiver 38. The media receiver 38 may be configured in various arrangements. For example, the media receiver 38 may comprise a pre-amplifier, an amplifier, a decoder that decodes media for playing the media in one of a variety of play modes, and a radio frequency tuner. As another example, the media receiver 38 may comprise a video projector, television and/or monitor 36. As yet another example, the media receiver 38 may be a video projector, television or monitor. Other exemplary arrangements of the media receiver 38 are also possible.

The video projector may comprise a ceiling mounted device that projects a video signal onto a wall or a ceiling mounted screen. Other examples of the video projector are also possible. Hereinafter, “monitor 36” will refer to the video projector, the television, the monitor, or some other video equipment capable of displaying a video media unit.

The main processor 15 could comprise one or more processors, such as a general purpose processor and/or a digital signal processor. The main processor 15 executes program instructions in order to work cooperatively with the plurality of media source I/O ports 12, the control port system 14, the user interface 16, the mode configuration process 17, and the media player interface 18. As an example, the processor 15 may execute computer-readable program instructions that cause the user interface 16 to send to a display 32 messages to query a user to select receiver connections and play mode characteristics for media playable via the media receiver 38.

The plurality of media source I/O ports 12 are coupled to a plurality of media source devices or systems. By way of example, the plurality of devices or systems may include the Internet 20, a personal computer 24, a first disc changer 26a, a second disc changer 26b, and a third disc changer 26c. The disc changers 26a, 26b, 26c, may be devices that optically read data stored on optically-readable discs such as a CD or DVD. As another example, one or more of the I/O ports may be connected to a source for television program signals (i.e., viewable media). The source for television program signals may be a television antenna (e.g., a satellite antenna), or a cable headend of a cable television provider. Other exemplary devices or systems coupled to the plurality of media source I/O ports 12 are also possible.

The Internet 20 is preferably connected to a network hub 22, which provides Internet access to the personal computer 24 in a local area network environment. The personal computer 24 may connect to the media management system 10 using any suitable data connection 21 (e.g. RS232, Ethernet, wireless Ethernet, etc.). In a preferred embodiment, the personal computer 24 connects to the media management system 10 at an Ethernet connection over which the media management system 10 connects to the Internet 20.

The media receiver 38 may interface to the data connection 21. The media receiver 38 and the media management system 10 may communicate control instructions and/or media (e.g., audio media and video media) via the data connection 21. The communications via the data connection 21 may occur in addition to or as an alternative to some or all of the communications carried over the control signal connection 51, the digital connection 52, the 2-channel analog connection 54, the 6-channel analog connection 56, and/or the video connection 58. In other words, some or all of the communications carried between the media receiver 38 and the media management system 10 via the data connection 21 may be redundant communications. The first, second and third disc changers 26a-c may be any disc changer operable to hold and play a plurality of media discs such as audio CDs (compact discs), Super Audio CD's (SACD), DVDs (digital versatile disc or digital video disc), high-definition DVDs, or blu-ray discs (BD). The disc changers 26a-c connect to the media management system 10 at the media source I/O ports 12 to communicate media to the media management system 10. Disc players operable to hold and play a single disc may alternatively or additionally be connected to the I/O ports 12.

The media management system 10 may include a control port system 14 for controlling the disc changers 26a-c. The control port system 14 may provide control signals to disc changers 26a-c via infrared (IR) (e.g. wired IR or wireless IR), or serial connections (e.g. two-way serial or S-Link based connections). Other examples of control signal types provided by the control port system 14 to the disc changers 26a-c are also possible.

The control port system 14 may interface (e.g. via an RS-232 serial cable) with a home remote control system 28. As an example, the home remote control system 28 may provide control for the media management system 10, as well as control for other systems, such as appliances and/or a furnace in a home.

The video connection 58 may comprise one or more video connections. For example, the video connection 58 may comprise one or more analog video connections, such as a composite video connection (i.e., a Composite Video Blanking and Sync (CVBS) connection), an S-video connection, a component video connection (e.g., a red connection, a green connection, and a blue connection), or some other analog video connection. Alternatively or additionally, the video connection 58 may comprise one or more digital video connections, such as a High-Definition Multimedia Interface (HDMI) connection, a digital visual interface (DVI) connection, a display port connection, or some other digital connection.

The media management system 10 accesses each of the plurality of media sources and organizes information about the media that is accessible to the user of the media management system 10 in the media database. The media database 19 may be any type of storage system. For example, the media database 19 may comprise a disc-based mass storage device, a flash memory system, or a combination of flash memory and disc-based memory. As another example, the media database 19 may comprise volatile and/or non-volatile storage components, such as optical, magnetic, organic or other memory or disc storage, which can be integrated in whole or in part with the processor 15.

The media database 19 stores media unit records, i.e., records containing information about media units that may be received from the media sources. The media database 19 may also store computer-readable program instructions executable by the processor 15 and media units playable by the media receiver 38 and/or video equipment such as the monitor 36. The functions identified herein as being carried out at the display 32 may be carried out at the monitor 36. Similarly, the functions identified herein as being carried out at the monitor 36 may be carried out at the display 32.

As used herein, the term media unit shall refer to any playable or renderable piece of media, such as a song, a movie, a picture, a track on a disc, a portion of audio/visual programming, or any other audio and/or video segment. The playable piece of media may comprise audio and video media suitable for playing on the monitor 36. The monitor 36 may comprise a cathode ray tube (CRT) display, a liquid crystal display (LCD), a plasma display or another type of display.

A media unit may be received at the media management system 10, media receiver 38, and/or the monitor 36 via (i) the Internet 20, (ii) a media signal transmitted from a satellite (e.g., a satellite operated by Direct TV of El Segundo, Calif.), (iii) the media source I/O ports 12, (iv) the connections 51, 52, 54, 56, 58, or (v) via some other means.

In exemplary embodiments, a media unit record contains information in the form of characteristics such as a title (e.g. a CD title, a DVD title, or a movie title), a song, a genre, a location, an artist, a date, and/or a media type. The location defines the location of the media unit on the media source. For example, a media unit record for a song may denote that the song is located in a particular slot on a particular tray in a particular one of the CD changers 26a, 26b, 26c. As another example, a media unit record for a song may denote that the song is located as a particular track on a disc, such as a CD, DVD, and/or SACD. An artist defines a performer's work or group of performers' work recorded as a media unit. A date, for example, may define the day which a media unit was recorded or a day the media unit was released by a recording studio. Other examples of the date are also possible.

The media type defines the format used to encode a media unit. Various media types are available for encoding audio. For example, a media type may include the Motion Picture Experts Group—audio layer 3 (MP3) format, a CD format, a SACD format, a DVD format, a waveform audio (WAV) format, pulse code modulation (PCM) format, free lossless audio code (FLAC) format, or an advance audio coding (AAC) format. The media type may also define whether the media unit is encoded as (i) encrypted or unencrypted media, or (ii) compressed or uncompressed media. Other examples of formats for digitally encoding audio are also possible.

Further, a media type format may have a variety of encoding characteristics. For example, an audio recording may be encoded as an MP3 file in mono format having a data rate of 96K bits per second (bps), or as an MP3 file in stereo format having a data rate of 96K bps, or as an MP3 file in stereo format having a data rate of 192K bps. As another example, the AAC format could be encoded using a variable bit rate or a constant bit rate and with a different amount of audio channels, (e.g. 1 channel, 2 channels, etc.). Other examples of encoding characteristics of the MP3 format, the AAC format, or other media type are also possible.

The media management system 10 may display selected information of a media unit record on a display 32. The media management system 10 may allow a user to configure and select media to play using a keyboard 34, an IR remote control 30 or another suitable input device. The media management system 10 may include a user interface 16 that processes user input and output via the display 32 and the keyboard 34 and provides configuration and execution processes to allow the user to manage and play the media obtained from the media sources. As an example, the display 32 may comprise a touch-screen that allows a user to (i) configure and select media, and (ii) select play modes, by touching the touch-screen while a configuration and selection screen is shown on the display 32.

In a preferred embodiment, the user interface 16 may be coupled to the processor 15. The processor 15 may execute computer-readable program instructions so as to carry out a configuration process 17 that allows the user to configure the media receiver 38 to play selected media in accordance with requirements specified in a play mode. The configuration process 17 may cause the display 32 to display screens to prompt a user to enter information about play modes for various types of media types and/or for particular media units.

As an example, the user may specify that a song (e.g., an audio media unit) in an MP3 format will be played on a receiver via a 2-channel analog connection. In this regard, for 2-channel analog, the media management system 10 processes the MP3 song by extracting the left and right channel analog signals of the MP3 song and then sends the left and right analog signals 55 to a corresponding 2-channel analog connection at the media receiver 38. The media receiver 38 may process the left and right channel signals 55 by amplifying the signals before outputting the signals to a left speaker and a right speaker respectively.

As another example, the MP3 song may also be communicated digitally (in MP3 or another digital format) to another digital player. In this regard, the user may specify a receiver connection that sends a digital signal 53 from the digital connection 52 to a corresponding digital connection at the media receiver 38. As yet another example, the user may specify a receiver connection that sends 6-channel audio signals 57 from the 6-channel audio connection 56 to a corresponding 6-channel audio connection at the media receiver 38.

The 2-channel analog receiver connection is only one of many media receiver connections that may be specified for a given media type. Other examples of media receiver connections include: (i) 5.1 analog connections, and (ii) digital connections, such as a 2-channel digital connection, a 5-channel digital connection, or a 7-channel digital connections. Other examples of media receiver connections are also possible. These media receiver connections may correspond directly to the connections available on the media receiver 38. FIG. 1 shows a digital connection 52, a 2-channel analog connection 54, and a 6-channel audio connection (e.g. for use with 5.1 modes) 56.

Audio signals received at the media receiver 38 may be played through one or more speakers coupled to the media receiver. As an example, the media receiver 38 is shown as being connected to a first speaker 40 (e.g. a speaker for a left-audio channel), a second speaker 42 (e.g. a right-channel speaker), and a third speaker 44 (e.g. a speaker for a center-audio channel). Other examples of the amount of speakers coupled to the media receiver 38 and/or the audio signal played through a particular speaker are also possible.

The media receiver 38 may also drive video equipment, such as a video projector, television or monitor 36 via a video connection 58. In this regard, a video signal 59 is sent to the video projector, television or monitor 36. The video signal 59 may be arranged according to any of a variety of video formats. The video formats may include compressed media (video and/or audio content), uncompressed media, or a combination of compressed and uncompressed media. Examples of video formats include: (i) Motion Picture Experts Group (MPEG)-1, (ii) MPEG-2, (iii) MPEG-4, (iv) high definition television (HDTV), (v) National Television System Committee (NTSC), (vi) Phase Alternating Line (PAL), (vii) Joint Photographic Experts Group (JPEG), and (viii) Video-CD. Other examples of video formats are also possible.

The media receiver 38 may use specific play modes for audio media. For example, a Denon receiver may be commanded to configure the receiver according to special play modes that the receiver is designed to understand. The media management system 10 may send commands specifying play modes, such as (i) Digital Theater System (DTS) (e.g. DTS-ES, DTS-Neo:6, DTS-Digital Surround, or DTS-96/24), (ii) Dolby Pro Logic (DPL) (e.g. DPL II, DPL Movie, or DPL Music), (iii) Dolby Digital (e.g. Dolby Digital EX) (iv) THX (e.g. THX Cinema), (v) Wide Screen, (vi) Super Stadium, (vii) Rock Arena, (viii) Jazz Club, (ix) Classic Concert, (x) Mono Movie, (xi) Matrix, (xii) 5-Channel Stereo, (xiii) 7-Channel Stereo, (xiv) Stereo, (xv) Pure Direct, or (xvi) Direct.

The media receiver 38 may also use specific play modes for video media units. As an example, the play modes for video may comprise a play mode having a particular video aspect ratio such as a 1.33:1 ratio, a 1.77:1 letterbox ratio, a 1.77:1 anamorphic ratio, a 1.85:1 letterbox ratio, a 1.85:1 anamorphic ratio, a 2.35:1 letterbox ratio, a 2.35:1 anamorphic ratio, or some other video aspect ratio.

These play modes (and others that may be defined) may be used with media receivers (e.g. media receiver 38) that are able to interpret these play modes and configure characteristics of the media receiver to play the media. The specific play modes may identify one or more of the configurable characteristics. For audio media, the configurable characteristics may include equalization (e.g. equalizer settings), level adjustments (e.g. input level, or speaker level), delay time, noise reduction, bass setting, and a balance setting. For video media, the configurable characteristics may include contrast, brightness, hue, color, sharpness, color temperature, and noise reduction. Other examples of configurable characteristics are also possible.

In a preferred embodiment, the media management system 10 couples a control signal 50 to the media receiver 38 to communicate configuration instructions for playing a particular media unit. The control signal 50 may communicate commands to configure the media receiver 38. The commands may be specific to the type (brand or make) of receiver based on the receiver's command set. For example, the media receiver 38 may be a Denon brand or Marantz brand receiver controllable by the control signal 50. Exemplary Denon brand receivers controllable by the control signal 50 include receivers having the model number: (i) AVR-2803, (ii) AVR-3803, (iii) AVR-4802R, or (iv) AVR-5803. Exemplary Marantz brand receivers controllable by the control signal 50 include receivers having the model number: (i) SR7300, (ii) SR7300se, (iii) SR8200, (iv) SR8300, or (v) SR9300. These Denon and Marantz brand receivers are controllable using an RS232 connection to carry the control signal 50. Other receivers and other types of control connections may be used as well.

In an exemplary embodiment of the present invention, the media management system 10 configures the media receiver 38 to play media using a selected receiver connection. The selected receiver connection is used to configure the media receiver 38 by ensuring that the media is communicated on the receiver connections corresponding to the media type (e.g. encoding format such as MP3, SACD, DVD-Audio, FLAC, AAC, etc.). In accordance with the exemplary embodiment, a user is provided with access to the configuration process 17 so as to configure how media will be played automatically as a function of its media type and/or genre, artist, or any other suitable characteristic that may be included in a media unit record.

2. An Exemplary Configuration Process

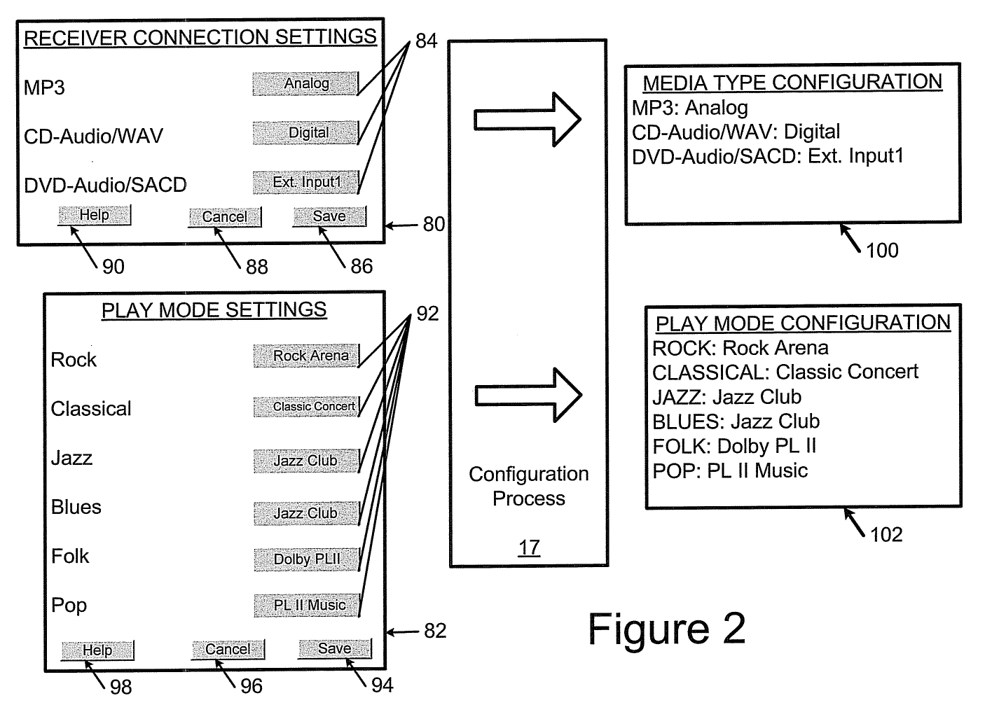

FIG. 2 depicts operation of the configuration process 17 that may be used in the media management system 10. The configuration process 17 is preferably invoked during a setup stage during which a user configures the media management system 10 for operation. During the setup stage, the user may connect all of the necessary equipment to the media management system 10 and go through various interactive stages of inputting information to enable the media management system 10 to perform its functions. For example, one interactive stage may entail setting up service with an Internet Service Provider to be able to communicate with a web-site that provides downloadable media.

In the configuration process 17, the user may enter a receiver configuration stage involving a receiver connection setting screen 80 and a play mode setting screen 82. Referring to the receiver connection setting screen 80, the user may select receiver connections from drop-down menus 84 for each media type listed. The user may then save the selections to the media type configuration record 100 by clicking on a ‘SAVE’ button 86. The user may click a ‘Cancel’ button 88 to start again, or a ‘Help’ button 90 to get interactive help services. The user may also select play modes from drop-down menus 92 on the play mode setting screen 82. As an example, the play modes may be correlated with a particular genre (or another one of the plurality of characteristics) of the media units available for play by the media receiver 38. The user may save play mode selections to a play mode record 102 by clicking on the ‘SAVE’ button 94.

Those of ordinary skill in the art will appreciate that the receiver connection setting screen 80 and the play mode setting screen 82 are shown as examples of configuration screens that a user may use to select how the media receiver 38 will be automatically configured to play a selected media unit. The play mode setting screen 82 may use other characteristics, such as artist, title, or location, to select the play mode that will be used by the media receiver 38 when playing the selected media unit. Other examples of the receiver connection setting screen 80 and/or the play mode setting screen 82 are also possible.

3. An Exemplary System and Method for Playing Media

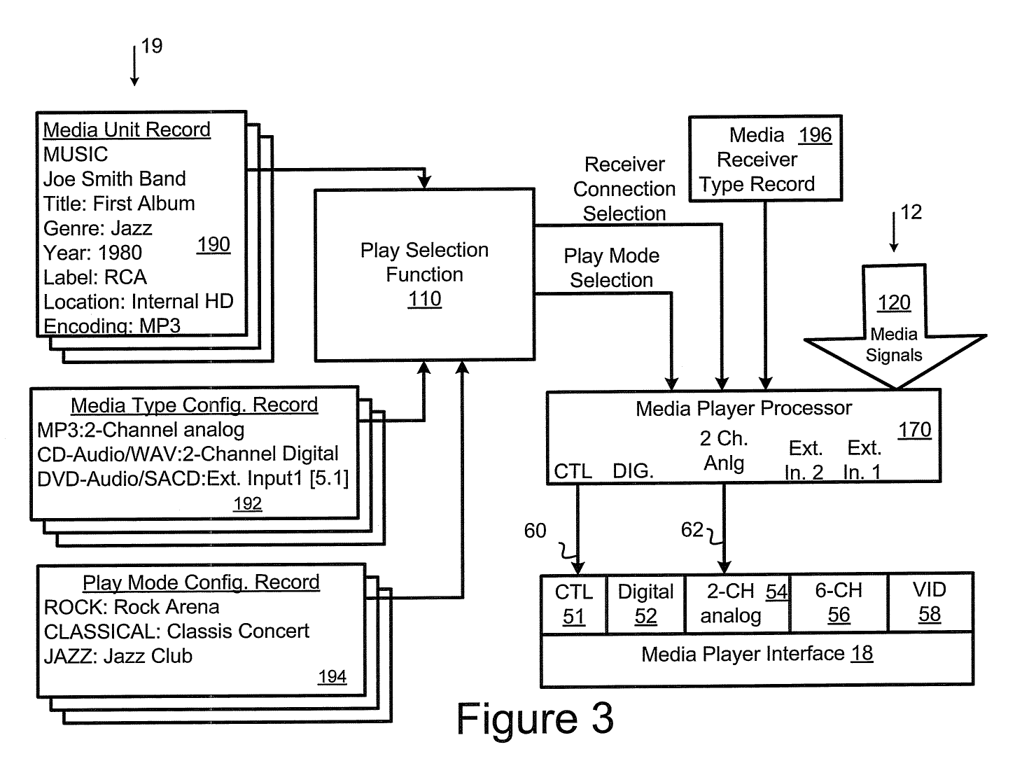

FIG. 3 depicts operation of the media management system 10 for automatically selecting a play mode and a receiver connection for configuration of the media receiver 38. Various events and/or timing may be used to trigger the automatic selection of a play mode and receiver connection. For example, the automatic selection may occur in response to installing a disc into a disc player, such as the first CD changer 26a. As another example the automatic selection may occur in response to receiving a stream of media from a data storage device. In this regard, the data storage device could be local to the media management system 10 or remote from the media management system, such as at a data storage device at the personal computer 24 or on the Internet 20. Other examples of triggering the automatic selection of a play mode and receiver connection are also possible.

FIG. 3 depicts the media player interface 18, a play selection function 110, a media play processor 170, a media unit record 190, a media type configuration record 192, a play mode record 194, and a media receiver type record 196.

The media unit record 190, the media type configuration record 192, the play mode record 194, and the media receiver type record 196 may be stored in the media database 19. The media management system 10 may comprise a plurality of media unit records, each corresponding to a particular media unit. Further, the media management system 10 may include a plurality of media type configuration records, play mode records, and media receiver type records, such as to accommodate the preferences of more than one user of the system 10.

The play selection function 110 may be carried out by processor 15 executing computer-readable program instructions. The play selection function 110 may retrieve one or more records from the media data base 19. For example, the play selection function 110 retrieves a media unit record 190 from the media database 19 for a selected media unit. The media unit may be selected directly when the user selects the media unit from the user interface 16. The media unit may also be selected as part of a playlist that contains the name of the media unit and retrieves the information while processing the songs on the playlist. The playlist may be user defined or pre-defined in an album or other type of collection of media units.

The media unit record 190 contains information about the media unit selected for play. As an example, the media unit record 190 may include information that identifies (i) a media unit as an audio (music) or a video media unit, (ii) an artist name, such as “Joe Smith” (iii) a title, such as “Joe Smith's First Album” (iv) a genre, (v) a date, such as a recording date, (vi) a label, such as Radio Corporation of America (RCA), (vii) a location, such as an internal hard drive in a personal computer, and (viii) a media type, such as MP3. Other examples of information in a media unit record 190 are also possible.

As another example, the play selection function 110 may retrieve a media type configuration record 192, which may be configured as described above with reference to the media type configuration record 100. The play selection function 110 determines the media type for the selected media unit from the media unit record 190. In the example shown in FIG. 3, the media type of the media unit identified in the media unit record 190 is MP3. The play selection function 110 then determines a receiver connection selection for the selected media type by reference to the media type record 192.

For instance, the receiver connection shown in the media type configuration record 192 for MP3 is 2-Channel Analog. As additional examples, if the media type is CD-audio or a WAV file, then the receiver connection is 2-channel digital, or if the media type is DVD-audio or SACD, then the receiver connection is the analog 5.1 connection. Other examples of receiver connections identified in the media type configuration record 192 are also possible.

As another example, the play selection function 110 may retrieve a play mode record 194. The play mode record 194 includes play modes that correspond to a genre characteristic of a media unit. As an example, a play mode “rock arena” corresponds to a rock genre, a play mode “classic concert” corresponds to a classical genre, and a play mode “jazz club” corresponds to a jazz genre. As another example, a user may select a play mode “rock arena” for a jazz genre. Other examples of play modes corresponding to a characteristic of a media unit are also possible.

The play selection function 110 determines a play mode selection based on the media unit record 190 and the play mode record 194. For instance, since the genre characteristic of the media unit record 190 is Jazz and the play mode for the Jazz genre is Jazz Club (as defined by the play mode record 194), the play selection function 110 determines the play mode selection as being Jazz Club.

The play selection function 110 interfaces to a media play processor 170 or the processor 15 to communicate the play mode selection and the receiver connection selection for a selected media unit. The media play processor 170 receives the play mode selection, the receiver connection selection, as well as a media receiver type record 196. The media receiver type record 196 identifies the type of receiver coupled to a media management system. For example, the media receiver type record 196 may identify a receiver as being a Denon brand receiver having a model number of AVR-2803.

The media play processor 170 receives the media signals 120 of the selected media unit from the media source I/O ports 12. The media play processor 170 uses the receiver connection selection and the media receiver type record to determine the selected receiver connection and to couple the media signals 120 to the selected receiver connections at the media player interface 18. The media play processor 170 uses the play mode selection, the receiver connection selection, and the media receiver type record to determine which instruction(s) to send the media receiver 38 for configuration of the media receiver 38.

In one exemplary embodiment, the media play processor 170 communicates a control signal 60 to the control signal connection 51, for transmission in turn to the media receiver 38. The control signal 60 communicates a control instruction to the media receiver 38 that instructs the media receiver 38 to use a particular receiver connection and one of a plurality of play modes in accordance with the instruction. For example, the media play processor 170 may request that the media receiver 38 use a play mode called “Rock Arena.” The media receiver 38 would be capable of using various specific settings of characteristics such as tone, equalizer settings, noise reduction, delay time, bass setting, balance setting, and level adjustments to output sound in a manner that may be characterized as sounding like “Rock Arena.” The media receiver 38 would also be compatible with the control instruction it receives.

As another example, the media play processor 170 may request that the media receiver 38 switch an input source for media signals to a particular receiver connection. In this regard, the media play processor 170 requests the media receiver 38 to use receiver connections of the media receiver that are coupled to receiver connections at the media player interface 18. For example, the media play processor 170 may request that the media receiver use a 2-channel analog receiver connection that is coupled to the 2-channel analog connection 54. In this regard, the media play processor 170 will route the media signals 120 to the 2-channel analog connection 54 as 2-channel analog signals 62, for transmission in turn to the 2-channel analog receiver connection at the media receiver 38. Other signals that may be sent by the media play processor 170 are signals sent to the digital connection 52, the 6-channel analog connection 56, or the video connection 58. These signals are not shown for clarity of the example above.

Specific media receivers are already capable of such functionality. Tables 1-10 contain categories of control instructions and other information that may be communicated to the media receiver 38 on a control signal 50 to configure the media receiver 38. The control instructions in Tables 1-10 are for a Denon brand receiver having model number AVR-SR9200. Those of ordinary skill in the art will appreciate that Tables 1-10 shows just one example of the types of control instructions that may be defined for a media receiver.

TABLE 1
Normal Command List
Sample Command ID = 1

| Command | | Priority | Character | Sample |
|---|---|---|---|---|
| Power | Power | LOW | A0 | “@1A0”, 0x0D |
| | Power ON | HIGH | A1 | |
| | Power OFF | HIGH | A2 | |
| INPUT | DSS | HIGH | B0 | |
| | TV | HIGH | B1 | |
| | LD | HIGH | B2 | |
| | DVD | HIGH | B3 | |
| | VCR1 | HIGH | B4 | |
| | VCR2/DVD-R | HIGH | B5 | |
| | AUX1 | HIGH | B6 | |
| | AUX2 | HIGH | B7 | |
| | DVD-R (Not useable in this Model) | — | B8 | |
| | CD | HIGH | B9 | |
| | TAPE | HIGH | BA | |
| | CD-R | HIGH | BB | |
| | FM | HIGH | BC | |
| | AM | HIGH | BD | |
| | MW (Same as AM) | HIGH | BE | |
| | LW | HIGH | BF | |
| | TUNER | HIGH | BG | |
| MULTI CHANNEL | M-ch. INPUT ON | HIGH | BH | |
| | M-ch. INPUT OFF | HIGH | BI | |
| INPUT SIGNAL | A_D | HIGH | BJ | |
| TUNNER FREQ | AUTO-TUNE | HIGH | C0 | |
| | FREQ UP | HIGH | C1 | |
| | FREQ DOWN | HIGH | C2 | |
| TUNNER PRESET | PRISET INFO | LOW | C3 | |
| | P-SCAN | LOW | C4 | |
| | PRESET UP | HIGH | C5 | |
| | PRESET DOWN | HIGH | C6 | |
| F-DIRECT | F-DIRECT | LOW | C7 | |
| TUNER MODE | T-MODE | LOW | C8 | |
| MEMO/CLR | CLR | LOW | D0 | |
| | MEMO | LOW | D1 | |
| DIRECT KEY | DIRECT KEY 0 | LOW | E0 | |
| (10Key)F | DIRECT KEY 1 | LOW | E1 | |
| | DIRECT KEY 2 | LOW | E2 | |
| | DIRECT KEY 3 | LOW | E3 | |
| | DIRECT KEY 4 | LOW | E4 | |
| | DIRECT KEY 5 | LOW | E5 | |
| | DIRECT KEY 6 | LOW | E6 | |
| | DIRECT KEY 7 | LOW | E7 | |
| | DIRECT KEY 8 | LOW | E8 | |
| | DIRECT KEY 9 | LOW | E9 | |

TABLE 2

| Command | | Priority | Character | Sample |
|---|---|---|---|---|
| SURROUND | AUTO | HIGH | F0 | “@1F0”, 0x0D |
| MODE | THX 5.1MUSIC | HIGH | F1 | |
| | THX SURR EX | HIGH | F2 | |
| | THX CINEMA | HIGH | F3 | |
| | DTS | HIGH | F4 | |
| | DTS ES | HIGH | F5 | |
| | DOLBY | HIGH | F6 | |
| | DOLBY PROLOGIC | HIGH | F7 | |
| | DOLBY PRO LOGIC II MOVIE | HIGH | F8 | |
| | DOLBY PRO LOGIC II MUSIC | HIGH | F9 | |
| | VIRTUAL | HIGH | FA | |
| | S DIRECT | HIGH | FB | |
| | MOVIE | HIGH | FC | |
| | HALL | HIGH | FD | |
| | MATRIX | HIGH | FE | |
| | Mch-STEREO | HIGH | FF | |
| | STEREO | HIGH | FG | |
| | MONO | — | FH | |
| | NEO6 CINEMA | HIGH | FI | |
| | NEO6 MUSIC | HIGH | FJ | |
| | THX Adv EX | HIGH | FK | |
| | CS5.1 MUSIC | HIGH | FL | |
| | CS5.1 CINEMA | HIGH | FM | |
| | SURR MODE | HIGH | FN | |
| VOLUME | VOLUME UP(SLOW) | HIGH | G0 | |
| | VOLUME DOWN(SLOW) | HIGH | G1 | |
| | VOLUME UP(FAST) | HIGH | G2 | |
| | VOLUME DOWN(FAST) | HIGH | G3 | |
| TONE | BASS UP | HIGH | G0 | |
| | BASS DOWN | HIGH | G1 | |
| | TREBLE UP | HIGH | G2 | |
| | TREBLE DOWN | HIGH | G3 | |
| SLEEP MODE | SLEEP | HIGH | H0 | |
| MUTE | MUTE OFF | LOW | H1 | |
| | MUTE ON | LOW | H2 | |
| VIDEO MUTE | VIDEO MUTE | LOW | H3 | |
| ATT | ATT | LOW | H4 | |
| TEST TONE | TEST TONE | LOW | I0 | |
| NIGHT | NIGHT ON/OFF | LOW | J0 | |

TABLE 3

| Command | | Priority | Character | Sample |
|---|---|---|---|---|
| DISPLAY OFF | DISP | LOW | J1 | “@1S0”, 0x0D |
| OSD | OSD | LOW | J2 | |
| MENU | MENU (OK) | HIGH | J3 | |
| | MENU OFF | HIGH | J4 | |
| CURSOL | CURSOL UP | HIGH | J5 | |
| | CURSOL DOWN | HIGH | J6 | |
| | CURSOL LEFT | HIGH | J7 | |
| | CURSOL RIGHT | HIGH | J8 | |
| RDS | RDS DISP MODE | LOW | J9 | |
| | RDS PTY | LOW | JA | |
| VR VAL RESET | V RESET | LOW | JB | |
| RE-EQ | RE-EQ | LOW | JC | |
| CH SELECT | CH SEL | LOW | JD | |
| CH LEVEL | CH LEVEL UP | LOW | JE | |
| | CH LEVEL DOWN | LOW | JF | |
| SELECT | SELECT | LOW | JG | |
| ENTER | ENTER | LOW | JH | |
| UP/DOWN | UP>> | LOW | JI | |
| | DOWN<< | LOW | JK | |

TABLE 4
Special Command List

| Command | | Priority | Character | Sample |
|---|---|---|---|---|
| MULTI | MULTI ROOM OFF | LOW | L0 | “@1L0”, 0x0D |
| | MULTI ROOM ON | LOW | L1 | |
| MUTE (MULTI) | MULTI ROOM MUTE | LOW | L2 | |
| VOLUME (MULTI) | MULTI VOLUME UP(SLOW) | LOW | M0 | |
| | MULTI VOLUME DOWN(SLOW) | LOW | M1 | |
| | MULTI VOLUME UP(FAST) | LOW | M2 | |
| | MULTI VOLUME DOWN(FAST) | LOW | M3 | |
| SLEEP MODE | MULTI SLEEP | — | N0 | |
| (MULTI) | | | | |
| MULTI SPEAKER | MULTI SPEAKER ON | LOW | N1 | |
| | MULTI SPEAKER OFF | LOW | N2 | |
| MULTI INPUT | MULTI INPUT ON | LOW | N3 | |
| | MULTI INPUT OFF | LOW | N4 | |

TABLE 5

| | | | |
|---|---|---|---|
| Command | Priority | Character | Sample |

| | | | | |
|---|---|---|---|---|
| CONNECTION | ON | HIGH | P0 | — |
| | OFF | HIGH | P1 | — |

TABLE 6
Request Status Command (Status Command) List

| Request Status | Request Command | Answer | Character |
|---|---|---|---|
| Power Status | “@1?A”, 0x0D | Power ON | A0(“@1A0”, 0x0D) |
| | | Power OFF | A1 |
| | | NON | A- |
| Video IN | “@1?B”, 0x0D | DSS | B0 |
| | | TV | B1 |
| | | LD | B2 |
| | | DVD | B3 |
| | | VCR-1 | B4 |
| | | VCR-2 | B5 |
| | | AUX1 | B6 |
| | | DVD-R | B7 |
| | | NON | B- |
| Audio IN | “@1?C”, 0x0D | DSS | C0 |
| | | TV | C1 |
| | | LD | C2 |
| | | DVD | C3 |
| | | VCR-1 | C4 |
| | | VCR-2/DVD-R | C5 |
| | | AUX1 | C6 |
| | | AUX2 | C7 |
| | | DVD-R (Not usable) | C8 |
| | | CD | C9 |
| | | TAPE | CA |
| | | CD-R | CB |
| | | FM | CC |
| | | AM | CD |
| | | MW | CE |
| | | LW | CF |
| | | Mch INPUT | CG |
| | | TUNER | CH |
| | | NON | C- |
| Input Mode | “@1?D”, 0x0D | DIGIAL | D0 |
| | | ANALOGUE | D1 |
| | | NON | D- |
| Tuner | “@1?E”, 0x0D | XXXX (76.0-108.0)FM | E0XXXX |
| Frequency | | (153-1602)AM | |
| | | NON | E- |
| Tuner | “@1?F”, 0x0D | PXX(Preset1^{˜}50) | F0XX |
| Preset | | NON | F- |
| Tuner mode | “@1?G”, 0x0D | AUTO STEREO | G0 |
| | | MONO | G1 |
| | | NON | G- |
| VOLUME | “@1?H”, 0x0D | VOL XXXdB(−90^{˜}+99) | H0XXX |
| Status | | max | H1 |
| | | min (∞) | H2 |
| | | NON | H- |
| Bass Status | “@1?I”, 0x0D | BASSXXdB(−9^{˜}+9) | I0XX |
| | | NON | I- |
| Treble Status | “@1?J”, 0x0D | TREBLEXXdB(−9^{˜}+9) | J0XX |
| | | NON | J- |
| ATT | “@1?K”, 0x0D | ATT ON | K0 |
| | | ATT OFF | K1 |
| | | NON | K- |

TABLE 7

| Request Status | Request Command | Answer Sample | |
|---|---|---|---|
| SURROUND | “@1?L”, 0x0D | AUTO | L0(“@1L0”, 0x0D) |
| MODE | | THX 5.1 | L1 |
| | | THX SURR EX | L2 |
| | | THX CINEMA | L3 |
| | | THX MUSIC | L4 |
| | | DTS MUSIC | L5 |
| | | DTS CINEMA | L6 |
| | | DTS ES | L7 |
| | | NEO 6 | L8 |
| | | NEO 6 MUSIC | L9 |
| | | D DIGITAL | LA |
| | | DD PRO LOGIC | LB |
| | | DD PRO LOGIC II MOVIE | LC |
| | | DD PRO LOGIC II MUSIC | LD |
| | | CS CINEMA | LE |
| | | CS MUSIC | LF |
| | | VIRTUAL | LG |
| | | S DIRECT | LH |
| | | MOVIE | LI |
| | | HALL | LJ |
| | | MATRIX | LK |
| | | Mch-STEREO | LL |
| | | STEREO | LM |
| | | MONO | LN |
| | | NON | L- |
| SLEEP Status | “@1?M”, 0x0D | SLEEP OFF | M0 |
| | | SLEEP XXX(1^{˜}120) | M1XXX |
| | | NON | M- |
| DISP Status | “@1?N”, 0x0D | DISPLAY ON | N0 |
| | | DISPLAY OFF | N1 |
| | | NON | N- |
| OSD Status | “@1?O”, 0x0D | OSD ON | O0 |
| | | OSD OFF | O1 |
| | | NON | O- |
| TEST TONE | “@1?P”, 0x0D | TEST TONE L | P1 |
| | | TEST TONE C | P2 |
| | | TEST TONE R | P3 |
| | | TEST TONE SR | P4 |
| | | TEST TONE SBR | P5 |
| | | TEST TONE SBL | P6 |
| | | TEST TONE SL | P7 |
| | | TEST TONE SW | P8 |
| | | TEST TONE ALL | P9 |
| | | TEST TONE OFF | P0 |
| | | NON | P- |
| TEST TONE | “@1?Q”, 0x0D | TEST TONE AUTO | Q0 |
| MODE | | TEST TONE MANUAL | Q1 |
| | | NON | Q- |
| NIGHT MODE | “@1?R”, 0x0D | NIGHT MODE ON | R0 |
| | | NIGHT MODE OFF | R1 |
| | | NON | R- |
| MENU | “@1?S”, 0x0D | MENU ON | S0 |
| | | MENU OFF | S1 |
| | | NON | S- |

TABLE 8

| Request Status | Request Command | Answer Sample | |
|---|---|---|---|
| F-DIRECT | “@1?T”, 0x0D | F-DIRECT ON | T0 |
| | | F-DIRECT OFF | T1 |
| | | NON | T- |
| P-FORMAT | “@1?U”, 0x0D | D DIGITAL(AC-3) | U0 |
| | | DD SURROUND | U1 |
| | | DD SURR EX | U2 |
| | | DTS | U3 |
| | | DTS ES | U4 |
| | | AAC | U5 |
| | | MPEG | U6 |
| | | MLP | U7 |
| | | PCM | U8 |
| | | HDCD | U9 |
| | | DSD | UA |
| | | OTHER | UB |
| | | NON_DETECTION | UC |
| | | NON | U- |
| SAMPLING | “@1?V”, 0x0D | 32K | V0 |
| FREQ | | 44.1K | V1 |
| FS | | 48K | V2 |
| | | 88.2K | V3 |
| | | 96K | V4 |
| | | 176.4K | V5 |
| | | 192K | V6 |
| | | OUT OF RANGE | V7 |
| | | NON | V- |
| □Channel Status | “@1?W”, 0x0D | XX(Bit6-01: on 0: off) | WXX |
| | | NON | W- |

TABLE 9
“ON/OFF” information is indicated “Bit” by “Bit”.

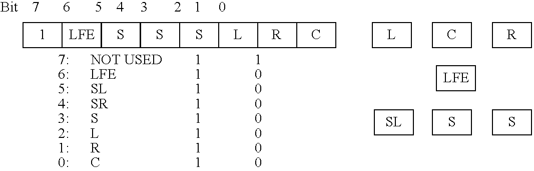

TABLE 10

| Request Status | Request Command | Answer Sample | |
|---|---|---|---|
| Multi Room Status | “@1?X”, 0x0D | Power ON | X0 |
| | | OFF | X1 |
| | | NON | X- |
| Video IN(MR) | “@1?Y”, 0x0D | DSS | Y0 |
| | | TV | Y1 |
| | | LD | Y2 |
| | | DVD | Y3 |
| | | VCR1 | Y4 |
| | | VCR2/DVD-R | Y5 |
| | | AUX1 | Y6 |
| | | DVD-R | Y7 |
| | | NON | Y- |
| Audio IN(MR) | “@1?Z”, 0x0D | DSS | Z0 |
| | | TV | Z1 |
| | | LD | Z2 |
| | | DVD | Z3 |
| | | VCR1 | Z4 |
| | | VCR2/DVD-R) | Z5 |
| | | AUX1 | Z6 |
| | | AUX2 | Z7 |
| | | CD | Z9 |
| | | TAPE | ZA |
| | | CD-R | ZB |
| | | MD | ZC |
| | | FM | ZD |
| | | AM | ZE |
| | | MW | ZF |
| | | LW | ZG |
| | | TUNER | ZH |
| Tuner Frequency | “@1?a”, 0x0D | NON | Z- |
| (MR) | | XXXX(76.0-108.0) FM (153-1602) AM | a0XXXX |
| Tuner Preset | “@1?b”, 0x0D | NON | a- |
| (MR) | | PXX(Preset1^{˜}50,255) | b0XX |
| VOLUME | “@1?c”, 0x0D | NON | b- |
| Status(MR) | | VOL XXX(−90^{˜}+99) | c0XXX |
| | | max | c1 |
| | | min (∞) | c2 |
| Volume Set Status | “@1?d”, 0x0D | NON | c- |
| (MR) | | Variable | d0 |
| | | Fixed | d1 |
| SLEEP Status(MR) | “@1?e”, 0x0D | NON | d- |
| | | SLEEP OFF | e0 |
| | | SLEEP XXX(1^{˜}120) | e1XXX |
| MULTI OSD | “@1?f”, 0x0D | NON | e- |
| | | MULTI OSD ON | f0 |
| | | MULTI OSD OFF | f1 |
| MULTI SPEAKER | “@1?g”, 0x0D | NON | f- |
| | | MULTI SPEAKER ON | g0 |
| | | MULTI SPEAKER OFF | g1 |
| MUTE (MR) | “@1?h”, 0x0D | NON | g- |
| | | MUTE ON (MR) | h0 |
| | | MUTE OFF (MR) | h1 |
| | | NON | h- |

4. Exemplary Video Media Unit Record

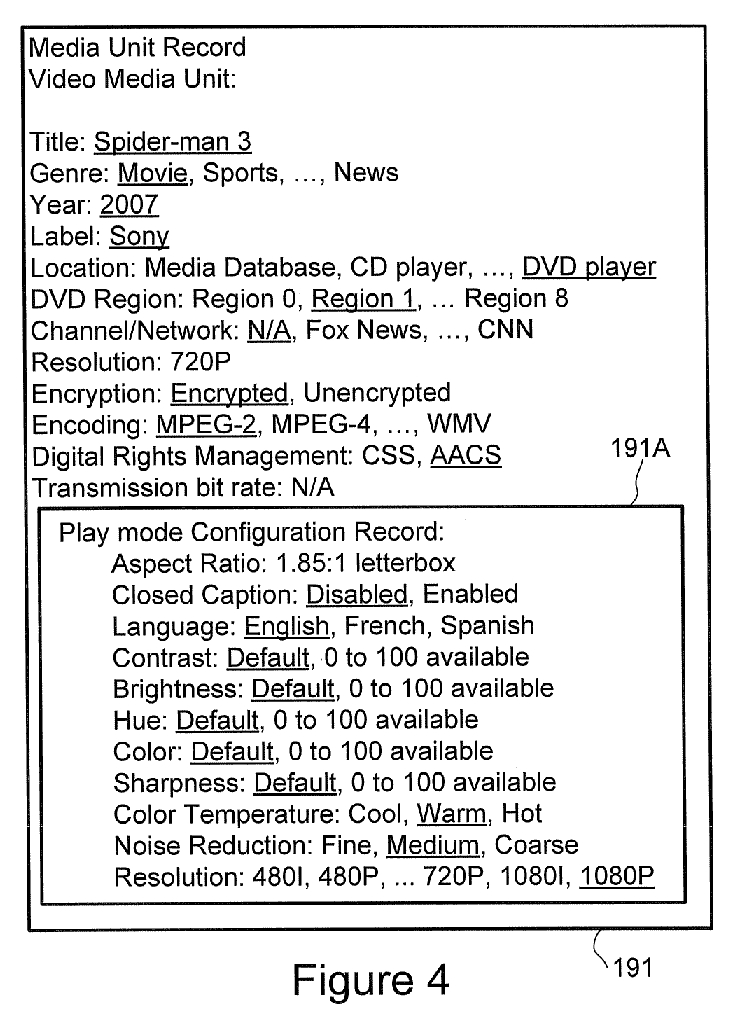

FIG. 4 depicts an exemplary media unit record 191 for an exemplary video media unit playable via the media receiver 38 and/or other video equipment such as the monitor 36. The media unit record 191 may be stored at the media database 19. The media unit record 191 comprises data about the exemplary video media unit, such as a title (e.g., Spider-man 3), a genre (e.g., movie), a year when the video media unit became available to users (e.g., 2007), a label indicating a producer of the video media unit (e.g., Sony, i.e., Sony Pictures Digital Inc.), a location of the video media unit (e.g., a DVD player), a DVD region of the video media unit, a channel/network provider (e.g., the Cable News Network (CNN)) of a video media unit, an encoding format, a resolution of the video media, encryption, digital rights management, and a transmission bit rate. The underlined text of FIG. 4 indicates various data values selected for the exemplary video media unit.

The DVD region may indicate a DVD region code intended to restrict the video media unit (stored on a DVD) to being played out via DVD players produced for sale in certain countries of the world. For example, a DVD region code of “1” indicates that a DVD is intended for use in Bermuda, Canada, the Cayman Islands, the United States, and United States territories. Additional region codes in addition to region 0 through region 8 may be defined.

The digital rights management (DRM) information may define a type of access control needed to play the selected video media unit. As an example, the DRM information may indicate a Content Scrambling System (CSS) is needed to play the video media unit. As another example, the DRM information may indicate an Advanced Access Content System (AACS) is needed to play the video media unit. Other examples of the DRM information are also possible.

The bit rate information may indicate a rate at which the video media unit is streamed (transmitted) to the media management system 10. In this regard, the processor 15 and/or the play selection function 110 may determine an appropriate receiver connection based on the bit rate information. For example, if the transmission bit rate is higher than a threshold bit rate (e.g., 12 mega bits per second), the processor 15 may determine that a wired Ethernet connection connected to the media receiver 38 should be used instead of a wireless Ethernet communication link. As another example, if the transmission bit rate is less than the threshold bit rate, the processor 15 may determine that a wireless Ethernet communication link may be used to carry the video media unit to the media receiver 38. Other examples of the threshold bit rate and use of the bit rate information to select a receiver connection are also possible.

The media unit record 191 includes a play mode configuration record 191A that corresponds to the video media unit identified by the media unit record 191. The play mode record 191A defines characteristics for playing out the video media unit via the media receiver 38 and/or other video equipment, such as the monitor 36. Each play mode characteristic may include a setting, such as a default setting established by a manufacturer of the media management system 10 or a user selectable setting. The user selectable setting may, for example, be selected via the user interface 16, the infrared remote control 30, and the configuration process 17.

As shown in FIG. 4, the play mode record 191A defines play mode characteristics (i.e., display characteristics) including an aspect ratio setting, a closed caption setting, a language setting, a contrast setting, a brightness setting, a hue setting, a color setting, a sharpness setting, a color temperature setting, a noise reduction setting, and a resolution setting. Other examples of play mode characteristics (such as the play mode characteristic shown in play mode configurations 102, 194) may also be defined and included in the play mode record 191A. In an alternative embodiment, the play mode record 191A may be separate and distinct from the media unit record 191.

The aspect ratio setting may be set to any of a variety of aspect ratios for playing out a video media unit, such as a 1.85:1 letterbox aspect ratio. The closed caption setting may be set to disabled setting or to an enabled setting. When closed captioning is enabled, the exemplary video media unit may be played out with subtitles for the hearing impaired.

The settings for contrast, brightness, hue and sharpness may each be a numerical value between 0 and 100. The manufacturer of media management system 10 may define default settings for contrast, brightness, hue, color, and sharpness, such as a default setting of 50. By way of example, a user may use the user interface 16, the infrared remote control 30, and the configuration process 17 to change one or more of the settings for contrast, brightness, hue and sharpness. A portion of the exemplary video media unit may be displayed on the monitor 36 while the user is setting the one or more settings for contrast, brightness, hue and sharpness.

The hue setting may represent an angle between two color components within a chromatic portion of a video media unit. The hue setting may be referred to as a “tint” setting.

The color setting may refer to a vividness of the hue. The color setting may be referred to as a “saturation” setting or a “picture” setting.

A setting for the color temperature characteristic may indicate a color of gray at different levels from a defined black color and a defined white color. As an example, the color temperature setting may be represented as a number of degrees Kelvin, such as a number of degrees Kelvin within the range of 6,000 degrees Kelvin to 12,000 degrees Kelvin. As another example, the color temperature characteristic may be represented to a user as cool, warm, and hot. In this regard, for example, a “cool” temperature may be defined as 6,000 degrees Kelvin, a “warm” temperature may be defined as 8,500 degrees Kelvin, and a “hot” temperature may be defined as 10,900 degrees Kelvin. A default color temperature may be defined by a manufacturer of the media management system 10. Other exemplary settings for the color temperature characteristic are also possible.

A setting for the noise reduction characteristic may indicate a user selectable setting of fine, medium, or coarse. A default noise reduction characteristic may be defined by a manufacturer of the media management system 10. Other exemplary settings for the noise reduction characteristic are also possible.

A setting for the resolution characteristic may indicate a user selectable resolution setting that the monitor 36 or other video equipment will display the video media unit. Exemplary resolution settings include 480I, 480P, 576I, 576P, 720P, 1080I and 1080P. Other exemplary resolution settings are also possible. The letter “I” in these resolution characteristics refers to “interlaced” and the letter “P” in these resolution characteristics refers to “progressive.” In some cases, a resolution setting may be set to a higher resolution than the actual resolution of the selected video media unit. In these cases, the media receiver 38 and/or the monitor 36 may attempt to convert (e.g., up convert) a lower resolution video media unit into a higher resolution video media unit.

Additionally, one of ordinary skill in the art will understand that the play mode record 191A may include additional characteristics and/or one or more of the characteristics shown in FIG. 4 may be omitted.

5. Exemplary Operation

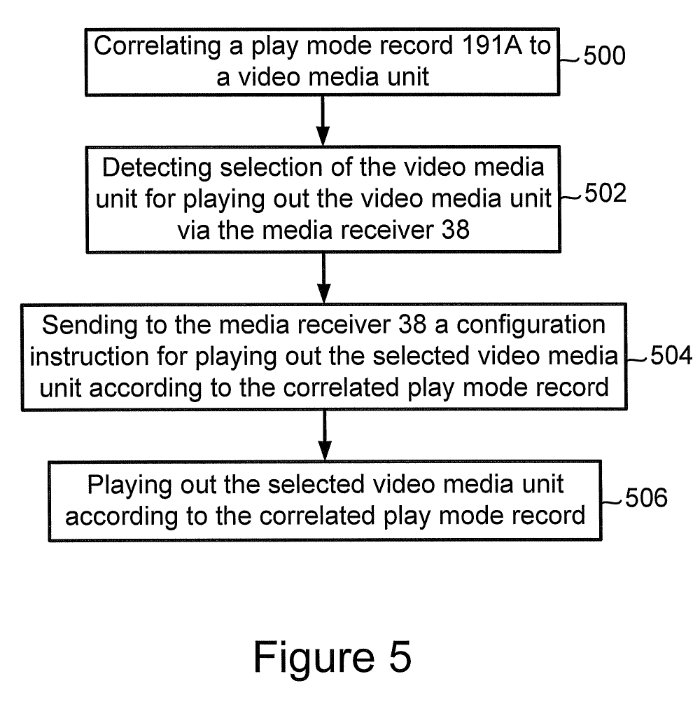

The media management system 10 carries out functions to configure the media receiver 38 for playing out media units, such as audio media units and/or video media units. FIG. 5 is a flow chart provided to illustrate a set of functions that may be carried out in accordance with an exemplary embodiment of the present invention. As shown in FIG. 5, block 500 includes correlating a video media unit with a play mode record 191A. In accordance with an embodiment in which the media unit is an audio media unit, the audio media unit may be correlated with the play mode record 190.

In one respect, the play mode record 191A may be predefined by a manufacturer of the media management system 10 such that each of the video play mode characteristics of play mode record 191A is set to a default setting. In this regard, the play mode record 191A may be referred to as a default play mode record.

In another respect, the play mode record 191A may include one or more video display characteristics set by a user via the user interface 16. The processor 15 may execute program instructions to carry out the configuration process 17 so as to cause the user interface 16 to query the user to select settings for the one or more characteristics via the infrared remote control 30 or another device that can select the settings.

The play mode record 191A may be correlated with more than one video media units. For example, a default play mode record may be correlated with a plurality of video media units. Additionally, a plurality of play mode records may be defined for a plurality of video media units such that each of the video media units is correlated with one of the of play mode records.

Next, block 502 includes detecting that the video media unit has been selected for playing out via the media receiver 38. The processor 15 may execute computer-readable program instructions to make the detection. For example, the processor 15 may execute the program instructions in response to receiving meta data from an optically readable disc installed into the disc changer 26a. As another example, the processor 15 may execute the program instructions in response to receiving from the user interface 16 a user selection requesting that the video media unit be played out.

In response to detecting selection of the video media unit, the processor 15 may access the media database 19 so as to determine the play mode record correlated with the selected video media unit and to determine from the play mode record the video display characteristics to be used to play out the selected video media unit. The processor 15 may then generate a configuration instruction to be sent to the media receiver 38 so as to inform the media receiver 38 of the video display characteristics of the play mode record 191A.

Next, block 504 includes sending to the media receiver 38 a configuration instruction for playing out the selected media unit according to the play mode correlated with the video media unit. As an example, the media management system 10 may send the configuration instruction to the media receiver via the control signal 50, the data connection 21 (e.g., an Ethernet data connection), or some other communication link. The communication link that carries the configuration instruction to the media receiver 38 may be a wired or wireless communication link.

After receiving the configuration instruction, the media receiver 38 (e.g., via a processor within the media receiver) may responsively execute program instruction so as to automatically configure the media receiver 38 for playing out the selected video media unit. After configuring the media receiver 38, the media receiver 38 may process the selected video media unit so that the media unit conforms to one or more of the video display characteristics of the play mode record 191A and thereafter provide the processed media unit to the monitor 36. As another example, the media receiver 38 may provide to the speakers 40, 42, 44 audio of the selected video media. In accordance with the play mode record 191A, the audio played out at the speakers 40, 42, 44 comprises audio comprising spoken words in the English language.

In addition to sending the configuration instruction, the media management system 10 may begin steaming the selected video media unit to the media receiver 38 and/or to the monitor 36.

Next, block 506 includes playing out the selected video media unit according to the correlated play mode. Playing out the selected video media unit may include the media receiver 38 sending the video media unit to the monitor 36.

As an example, the exemplary video media unit (i.e., Spider-man 3 stored at the media database 19 may be played out via the media receiver 38 and/or video equipment such as the monitor 36 using the video play mode characteristics of play mode 191A. In this way, a user is able to view the movie Spider-man 3 at the television or monitor 36 without any subtitles displayed and with English language speaking. Further, the user is able to view the movie Spider-man 3 with the monitor 36 showing the movie suing the aspect ratio, contrast, brightness, hue, color, sharpness, color temperature, and noise reduction as defined in the play mode record 191A.

6. An Exemplary System and Method for Playing a Video Media Unit

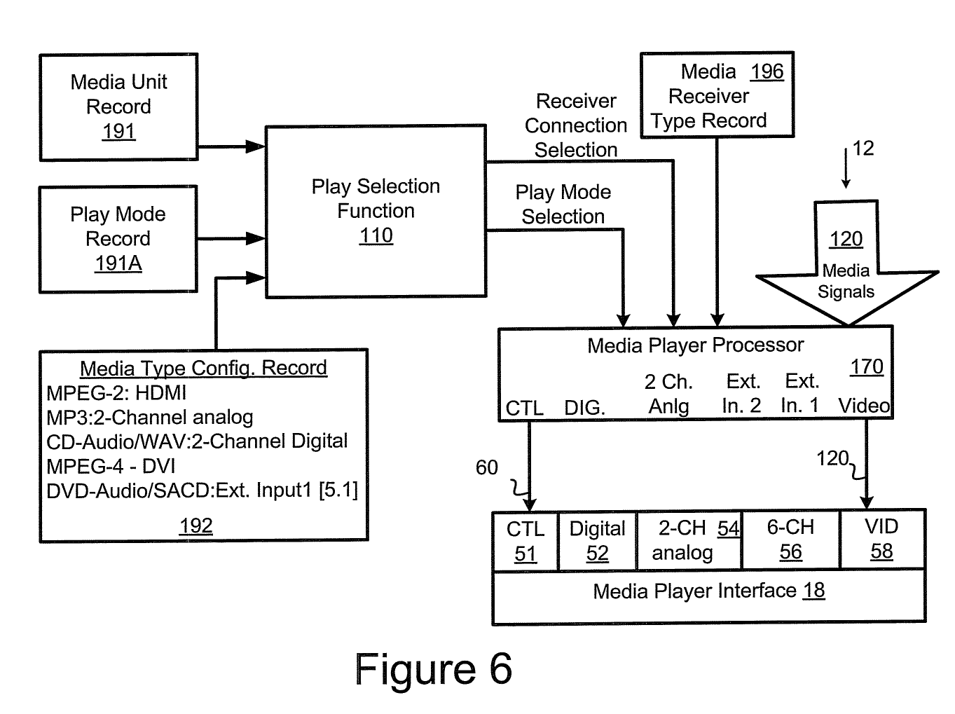

FIG. 6 depicts operation of the media management system 10 for automatically selecting a play mode and a receiver connection for configuration of the media receiver 38. Various events and/or timing may be used to trigger the automatic selection of a play mode and receiver connection, such as the events or time described above with respect to FIG. 3.

FIG. 6 depicts the media player interface 18, the play selection function 110, the media play processor 170, the media unit record 191, the media type configuration record 192, the play mode record 191A, and the media receiver type record 196. The media unit record 191, the media type configuration record 192, the play mode record 191A, and the media receiver type record 196 may be stored at the media database 19.

FIG. 6 depicts additional details of the media type configuration record 192. In particular and by way of example, the receiver connection for media encoded as MPEG-2 media may be an HDMI digital connection, and the receiver connection for media encoded as an MPEG-4 media may be a DVI digital connection. Other examples of video media encoding formats being associated with a given analog or digital video connection in the configuration record 192 are also possible.

The play selection function 110 is executable by the processor 15 to perform various functions for playing out a video media unit. For example, the play selection function 110 may retrieve one or more the records 191, 191A, 192, 196 in response to determining a given video media unit has been selected.

The play selection function 110 may determine from the media unit record 191 an encoding format/media type (e.g., MPEG-2) of the selected video media unit. The play selection function 110 may then determines a receiver connection selection (e.g., an HDMI connection) for the selected media type by reference to the media type record 192. The play selection function 110 may provide the receiver connection selection to the media play processor 170.

The play selection function 110 may determine a play mode selection based on the media unit record 191 and the play mode record 191A. The play selection function 110 may provide the play mode selection to the media play processor 170. The play mode selection may indicate one or more of the video display characteristics of the play mode record 191A.

The media play processor 170 may receive the play mode selection, the receiver connection selection, and the media receiver type record 196. The media play processor 170 may receive the media signals 120 of the selected media unit from the media source I/O ports 12. The media play processor 170 uses the receiver connection selection and the media receiver type record 192 to determine the selected receiver connection and to couple the media signals 120 to the selected receiver connections at the media player interface 18. The media play processor 170 uses the play mode selection, the receiver connection selection, and the media receiver type record 196 to determine which instruction(s) to send the media receiver 38 for configuration of the media receiver 38.

In one exemplary embodiment, the media play processor 170 communicates a control signal 60 to the control signal connection 51, for transmission in turn to the media receiver 38. The control signal 60 communicates a configuration instruction to the media receiver 38 that instructs the media receiver 38 to use a particular receiver connection and one of a plurality of play modes in accordance with the instruction. For example, the media play processor 170 may request that the media receiver 38 use the play mode defined in the play mode record 191A. The media play processor 170 or the media receiver 38 may provide the control instruction to the monitor 36. The media receiver 38 and/or the monitor 36 may be arranged to receive the configuration instruction and to responsively adjust video display characteristics, such as contrast, brightness, hue, color, sharpness, color temperature, and noise reduction so that the selected video unit is played out at the monitor 36 in accordance with the play mode defined by the play mode record 191A.

As another example, the media play processor 170 may request that the media receiver 38 use a particular input source at the media receiver 38 to receive video signals of the selected video media unit. In this regard, the media play processor 170 may request that the media receiver 38 use particular receiver connections that are coupled to receiver connections at the media player interface 18. For example, the media play processor 170 may request that the media receiver 38 use an HDMI receiver connection that is coupled to the video connection 58. In this regard, the media play processor 170 will route the media signals 120 to the video output of media play processor 170 for transmission, in turn, to the video connection 58 and the HDMI receiver connection of the media receiver 38.

7. Conclusion

Exemplary embodiments of the present invention have been described above. Those skilled in the art will understand, however, that changes and modifications may be made to the embodiments described without departing from the true scope and spirit of the present invention, which is defined by the claims.

Finally, the word “exemplary” is used herein to mean “serving as an example, instance, or illustration.” Any embodiment described herein as “exemplary” is not necessarily to be construed as preferred or advantageous over other embodiments.

1-31. (canceled)

32. A media management system comprising:
input connections connectable to a media source that provides video media signals to the input connections;
output connections connectable to a media receiver, wherein the output connections comprise (i) a control signal connection to output a configuration instruction to the media receiver, and (ii) a video connection to provide the video media signals to the media receiver;
a storage device containing a play mode record and a media unit record, wherein the play mode record defines a play mode corresponding to a characteristic of the video media signals, and wherein the media unit record contains information pertaining to the video media signals;
a user interface that allows a user to select the play mode for storage as the play mode record, and
a processor that receives a play mode selection based on the play mode record and the media unit record and that determines the configuration instruction to be output to the media receiver,
wherein the media receiver uses the configuration instruction to configure the media receiver to use the play mode for playing the video media signals.

33. The media management system of claim 32, wherein the play mode comprises a wide screen play mode.

34. The media management system of claim 32, wherein the play mode is correlated with a characteristic of the video media signals.

35. The media management system of claim 32, wherein the media receiver drives video equipment selected from the group consisting of (i) a television, and (ii) a monitor.

36. A method comprising:
correlating a video media unit with a play mode record;
detecting that the video media unit has been selected for playing out via a media receiver;
sending to the media receiver a configuration instruction for playing out the selected video media unit according to the play mode record correlated with the video media unit;
playing out the selected video media unit according to the correlated play mode record.

37. The method of claim 36, wherein the play mode record defines one or more video display characteristics selected from the group consisting of (i) contrast, (ii) brightness, (iii) hue, (iv) color, (v) sharpness, (vi) color temperature, and (vii) noise reduction.

38. The method of claim 36, wherein playing out the selected video media unit comprises the media receiver sending the video media unit to a television or a monitor.

39. The method of claim 36, wherein the video media unit comprises video media selected from the group consisting of: (i) video media transmitted from a satellite remote from Earth, (ii) video media received via an Internet network, and (iii) video media received via an Ethernet network.

40. The method of claim 36, wherein the video media unit comprises video media stored on an optically readable disc.

41. The method of claim 36, wherein the video media unit comprises video media stored on a magnetically readable disc.

42. The method of claim 36, further comprising:
prior to correlating the video media unit with the play mode record, receiving user inputs so as to define video display characteristics of the play mode record,
wherein the user inputs are received via a user interface of a media management system that interfaces to the media receiver, and
wherein the video display characteristics are selected from the group consisting of (i) contrast, (ii) brightness, (iii) hue, (iv) color, (v) sharpness, (vi) color temperature, and (vii) noise reduction.

43. The method of claim 36,
wherein the media receiver connects to a media management system via a communication link,
wherein the media management system comprises data storage that contains the correlated play mode record,
wherein detecting selection of the video media unit is carried out at the media management system,
wherein in response to detecting selection of the video media unit, the media management system responsively accesses the play mode record to determine the video display characteristics of the play mode record and to generate the configuration instruction, and
wherein the media management system sends the configuration instruction to the media receiver via the communication link.

44. The method of claim 36,
wherein the correlated play mode record is a default play mode record stored in data storage of a media management system that interfaces to the media receiver.

45. The method of claim 36,
wherein a media management system connects to the media receiver,
wherein the media management system comprises a processor, data storage, and a user interface,
the method further comprising prior to correlating the video media unit with the play mode record:
via the user interface of the media management system, querying a user to enter data that defines one or more video display characteristics selected from the group consisting of (i) contrast, (ii) brightness, (iii) hue, (iv) color, (v) sharpness, (vi) color temperature, and (vii) noise reduction;
at the processor, receiving the data that defines the one or more video display characteristics and responsively generating the play mode record to include the one or more video display characteristics; and
storing the play mode record at the data storage of the media management system.

46. The method of claim 36, wherein the media receiver comprises a display for playing out the video media unit.

47. The method of claim 44, wherein the media receiver is a television.
